(19) United States
(12) Patent Application Publication
(10) Pub. No.: US 2010/0051536 A1
(43) Pub. Date: Mar. 4, 2010

(54) FILTER INCLUDING MULTIPLE SPHERES

(75) Inventor: Kwangyeol Lee, Gyeongkido (KR)

Correspondence Address: EDWARDS ANGELL PALMER & DODGE LLP, P.O. BOX 55874, BOSTON, MA, 02205, US

(73) Assignee: Korea University Industrial & Academic Collaboration Foundation, Seoul (KR)

(21) Appl. No.: 12/199,697

(22) Filed: Aug. 27, 2008

(51) Int. Cl. B01D 29/50; B01D 29/56; C04B 33/32

(52) U.S. Cl. 210/489; 210/496; 264/628

(57) ABSTRACT

This disclosure relates to a filter including a plurality of spheres close-packed to form a thin layer.

### BACKGROUND

Certain products or devices such as a micro channel, a bio chip or a micro reactor are being manufactured in increasingly smaller sizes. The smaller sizes may mean that fluids used in the manufacture of these products should be of the highest purity possible. Fluid impurities, for example, can cause formation deficiencies in the products or devices mentioned above. Purification techniques, such as distillation may remove impurities but during the manufacturing process small particles or other types of unwanted fluid elements may cause impurities just before the fluids are actually used. Thus a filter to remove small (e.g., nanometer (nm) or smaller) particles or elements may be needed to help prevent or minimize impurities in fluids.

### SUMMARY

In one embodiment, a filter includes spheres close-packed to form a thin layer. The spheres have one or more nanometer-sized spaces between the spheres, where the nanometer-sized spaces are configured to remove elements in a fluid passed through the thin layer.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a side view of an illustrative embodiment of a filter.

FIG. 2 shows a top view of an illustrative embodiment of the filter.

FIG. 3 shows an illustrative embodiment of a macroporous pad.

FIG. 4 is a flow chart of an illustrative embodiment of a method for assembling a macroporous pad.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

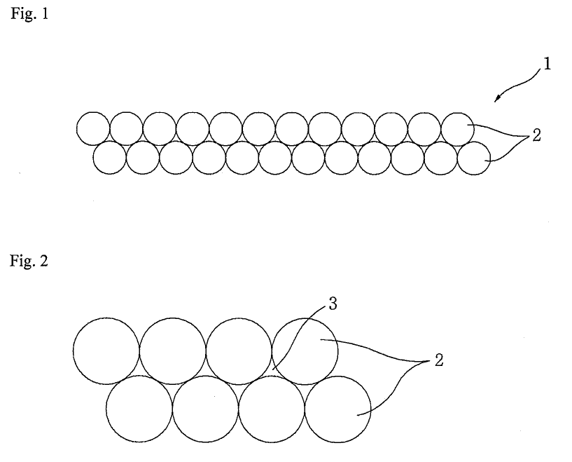

FIG. 1 shows a side view of an illustrative embodiment of a filter 1. In one example, as shown in FIG. 1, filter 1 includes spheres 2. In one embodiment, as shown in FIG. 1, spheres 2 include a plurality of spheres with gaps or spaces between each sphere that are shown as pores 3. Although spheres 2 are shown in two layers, any number of layers of spheres 2 may be used in filter 1.

FIG. 2 shows a top view of an illustrative embodiment of filter 1. The top view in FIG. 2, for example, shows another view of spheres 2 and pores 3. In one embodiment, spheres 2 may include, but are not limited to, materials such as beads of glass, synthetic resin, ceramic, silicon dioxide (SiO2), titanium dioxide, polymer beads, carbon or nanoreplica including copolymers used as the material of the sphere.

In one example, pores 3 may allow fluid (e.g., a liquid, a gas, etc.) to flow or pass between spheres 2. The diameter of a sphere from among spheres 2, for example, can be selectively adjusted according to the desired size of pores 3. For example, in order to make pores 3 larger, spheres 2 having a larger diameter can be used, and in order to make pores 3 smaller, spheres 2 having a smaller diameter can be used. Spheres 2, for example, may each have substantially the same diameter to form pores 3 that are substantially the same size. Thus, in this example, the size of pores 3 may determine the size of the particles or elements to be removed from the fluid that flows or passes through pores 3.

In one example, a surfactant can be used as a solution to adjust a surface energy for spheres 2. The spheres in spheres 2 may form a lump by surface tension. If the solution is evaporated, for example, the spheres of spheres 2 may become close-packed to each other by the surface tension of the solution and assembled by the self-assembled process to form a filter 1 with multiple layers as shown in FIG. 1. “Self-assembled process” used herein generally refers to a property of an atom or a molecule that is spontaneously aligned under an appropriate condition, but the meaning of the term is apparent to a skilled person in the art. These multiple layers, for example, may include spheres with relatively small diameters (e.g., nanometers or smaller). Each layer of close-packed spheres may individually form a thin layer or may form a thin layer that includes multiple layers of close-packed spears.

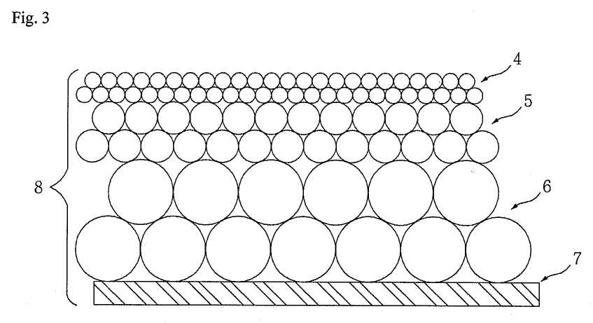

FIG. 3 shows an illustrative embodiment of a macroporous pad 8. In one example, macroporous pad 8 may be placed on a substrate 7 and includes filters 4, 5, and 6. Filters 4, 5, and 6, for example, may be similar to filter 1 described for FIGS. 1 and 2 and thus may each include spheres 2 and associated pores 3 that form a thin layer to filter a fluid. In one embodiment, spheres 2 for filter 4 are of a smaller sized diameter relative to spheres 2 of filter 5 and the spheres 2 for filter 5 are of a smaller sized diameter relative to spheres 2 of filter 6. This size relationship, for example, may be referred to as a hierarchical sized relationship. “Hierarchical” used herein refers to a size relationship of nano spheres situated on different layers.

In one example, macroporous pad 8 may filter a fluid that flows or passes through pores 3 of filters 4, 5 and 6. Filtering, for example, may include at least some pores 3 blocking small (e.g., nanometer-sized) particles or elements from the filtered fluid as the fluid passes through filters 4, 5, and 6.

Although FIG. 3 shows three filters, this disclosure is not limited to only a macroporous pad that has three filters that may each form a thin layer to filter a fluid. For example, a macroporous pad may have two, four or more filters.

When a fluid passes though macroporous pad 8, the fluid first passes through a substrate, for example, pores 3 located at the bottom of macroporous pad 8, then filter 4, and then filter 5, and then filter 6. Macro-sized impurities are first filtered when the fluid passes through pores 3, and then, impurities of smaller size are filtered when the fluid passes through filter 4. Then, while the fluid passes through filter 5 and filter 6, the fluid is further filtered to obtain a product of optimum size.

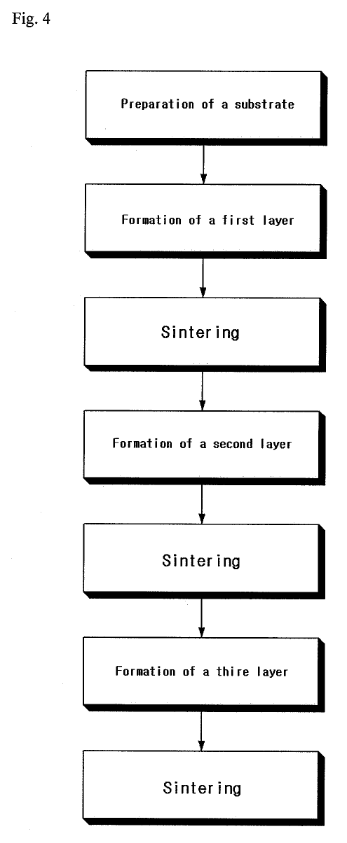

FIG. 4 is a flow chart of an illustrative embodiment of a method for assembling macroporous pad 8. The method shown in FIG. 4, for example, describes an illustrative embodiment for assembling or preparing macroporous pad 8 for filtering a fluid to possibly remove nanometer-sized fluid elements.

In block 410, for example, two or more nanometer-sized spheres 2 is mixed in a surfactant solution and the surfactant solution is placed on substrate 7 to form filter 6. The size of the spheres 2 of filter 6, for example, may be between approximately 100˜300 nm.

In one example, the surfactant solution is placed on substrate 7 by painting the surfactant solution on substrate 7 using a brush or other types of painting means. Then, for example, if the surfactant solution is evaporated by going through a sintering process, the liquid of the surfactant solution evaporates gradually, and each sphere of spheres 2 may become close-packed to each other by the surface tension generated by the liquid. The liquid, which may be a dispersant of the surfactant solution, slowly evaporates through the sintering process and by the capillary force of the evaporated liquid of the surfactant solution. As a result, for example, spheres 2 of filter 6 may be moved and self-aligned to have a similar structure as filter 1 described for FIGS. 1 and 2 above.

In block 420, for example, filter 5 may be formed on filter 6. In one embodiment, filter 5 may be formed using a surfactant solution as described above for filter 6. In this embodiment, the size of the nanometer-sized spheres 2 of filter 5 mixed in the surfactant solution may be between approximately 50˜100 nm. In one example, this surfactant solution is placed on filter 6 using a spraying method.

In block 430, for example, filter 4 may be formed on filter 5. In one embodiment, filter 5 may be formed using a surfactant solution as described above for filter 6. In this embodiment, the size of the nanometer-sized spheres 2 of filter 4 mixed in the solution, may be between approximately 20˜30 nm. In one example, this surfactant solution is placed on filter 5 by forming a film using a method such as the Langmuir-Blodgett method, any of a variety of vaporization methods, or any of a variety of spray methods, although forming the film is not restricted to the aforementioned methods.

The spheres (e.g., spheres 2) close-packed as above move close to each other as much as possible by the strong attraction force, and thus are assembled by self-alignment. The spheres (e.g., spheres 2) constituting such sphere combinations make a number of triangle-shaped, nano-sized pores (e.g., pores 3) where a circumference is constituted in a circle-like shape therebetween, such as illustrated in FIG. 2. Thus, each sphere (e.g., sphere 2) is able to retain the shape of the combination even when there is no solution by having the parts that are in contact adhered to each other.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A filter, including:
a plurality of spheres, the plurality of spheres close-packed to form a thin layer, having one or more nanometer-sized spaces between the plurality of spheres that are configured to remove elements in a fluid passed through the thin layer.

2. The filter of claim 1, wherein having the one or more nanometer-sized spaces includes one or more pores, the one or more pores to have a size based, at least in part, on the diameter of the plurality of spheres, and the plurality of spheres to have substantially the same diameter.

3. A macroporous pad including:
a first filter including a first plurality of spheres, the first plurality of spheres close-packed to form a first thin layer with one or more nanometer-sized spaces between the first plurality of spheres;
a second filter including a second plurality of spheres, the second plurality of spheres closed-packed to form a second thin layer with one or more nanometer-sized spaces between the second plurality of spheres;
a third filter including a third plurality of spheres, the third plurality of spheres closed-packed to form a third thin layer with one or more nanometer-sized spaces between the third plurality of spheres; and
a substrate, wherein the first filter is on the substrate, the second filter is on the first filter, and the third filter is on the second filter.

4. A macroporous pad according to claim 3, wherein a diameter associated with the first, second and third plurality of spheres increases hierarchically from the third filter to the first filter.

5. A method including:
forming a first layer by close packing a plurality of spheres on a substrate;
sintering the first layer;
forming a second layer by close packing a plurality of spheres on the first layer;
sintering the second layer;
forming a third layer by close packing a plurality of spheres on the second layer; and
sintering the third layer.
